(19) United States
(12) Patent Application Publication
(10) Pub. No.: US 2025/0046508 A1
(43) Pub. Date: Feb. 6, 2025

(54) COIL ASSEMBLY

(71) Applicant: 3M INNOVATIVE PROPERTIES COMPANY, St. Paul, MN (US)

(72) Inventors: Jinwook Kim, Hwaseong-si (KR); Seong-Woo Woo, Gwangju-si (KR)

(21) Appl. No.: 18/718,177

(22) PCT Filed: Dec. 12, 2022
(86) PCT No.: PCT/IB2022/062083

§ 371 Date: Jun. 10, 2024

(30) Foreign Application Priority Data
Dec. 13, 2021 (KR) 10-2021-0177867

(51) Int. Cl. H01F 27/28; H01F 27/29

(52) U.S. Cl. CPC H01F 27/2823; H01F 27/29

(57) ABSTRACT

The present disclosure relates to a coil assembly. Specifically, according to an embodiment of the disclosure, there is provided a coil assembly including: a coil; and at least one pair of terminals among first terminals, second terminals, and third terminals for electrically connecting different electronic devices, wherein the coil includes: major coil surfaces which face each other and are substantially planar; and at least a first film and a second film which are laminated and are wound to form a plurality of loops which are substantially concentric, and wherein the first film and the second film include at least one electrically conductive layer, respectively.

### TECHNICAL FIELD

The disclosure relates to a coil assembly.

### BACKGROUND

A recent portable electronic device having a battery embedded therein, such as a smartphone, a personal digital assistant (PDA), a tablet, etc., is required to be charged with power. Recently, a system for wirelessly transmitting power is increasingly used to charge a battery embedded in a portable electronic device, etc. Such a wireless charging system (wireless power charging (WPC)) transmits and receives power by using electromagnetic induction or resonance, and to achieve this, a coil is provided in an electronic device.

In addition, the portable electronic device may provide various functions such as a short-range wireless communication system (near field communication (NFC)) and a wireless electronic payment system (magnetic secure transmission (MST)), etc., as well as the wireless charging system. In particular, the portable electronic device may be provided with a plurality of coils in the electronic device in order to perform the short-range wireless communication and the wireless electronic payment system.

### SUMMARY

In general, a plurality of coils may be individually designed to satisfy their respective characteristics such as resistance, inductance, etc., but there may be difficulty in increasing performance of the plurality of coils in a limited region. To this end, the related-art coils may mostly be configured to cross over some patterns of the plurality of coils, and a pattern may be formed on a flexible printed circuit board (FPCB) through etching for the sake of precise patterning.

However, when a pattern is formed on an FPCB through etching, there may be restrictions on a minimum pattern width and a minimum pattern gap due to limitation on a chemical etching process. In other words, a gap between patterns may be required to be dense in order to implement a plurality of coils having different functions in a limited region, but there may be difficulty in implementing patterns densely since a normal FPCB process requires an inter-pattern gap of at least 100 um. Accordingly, a shape of patterning for implementing a plurality of coils may be complicated.

An embodiment of the disclosure has been developed based on the above-described background, and provides a coil assembly which can implement a plurality of coils having different functions in a coil which is manufactured through a sawing processing after a copper sheet is rolled into a roll shape.

### Technical Solution

According to an aspect of the disclosure, there is provided a coil assembly including: a coil; and at least one pair of terminals among first terminals, second terminals, and third terminals for electrically connecting different electronic devices, wherein the coil includes: major coil surfaces which face each other and are substantially planar; and at least a first film and a second film which are laminated and are wound to form a plurality of loops which are substantially concentric, wherein the first film and the second film include at least one electrically conductive layer, respectively, wherein the first film and the second film have a substantially coextensive thickness therebetween along a thickness direction of the coil, and have a substantially coextensive length therebetween in a winding direction of the coil, such that the substantially planar major coil surfaces include corresponding end surfaces of the first film and the second film, respectively, wherein any one of the first terminals is terminated on a first loop of the first film, and the other one of the first terminals is terminated on a second loop of the first film, wherein the second loop of the first film is relatively further inside than the first loop of the first film, wherein any one of the second terminals is terminated on a first loop of the second film, and the other one of the second terminals is terminated on a third loop of the first film, wherein the third loop of the first film is relatively further inside than the second loop of the first film, wherein any one of the third terminals is terminated on the first loop of the second film, and the other one of the third terminals is terminated on a second loop of the second film, wherein the second loop of the second film is relatively further inside than the third loop of the first film, wherein an electrically conductive wire on an outside of the coil connects the third loop of the first film with a third loop of the second film, and wherein the third loop of the second film is disposed between the first loop of the second film and the second loop of the first film.

In addition, there is provided a coil assembly including: a coil including a first coil, a second coil, and a third coil which are on a same plane; and at least one pair of terminals among first terminals, second terminals, and third terminals for electrically connecting different electronic devices, wherein the first coil includes a plurality of first loops, wherein the second coil and the third coil surround an outermost first loop of the first coil at least one time so as to form at least one second loop of the second coil and at least one third loop of the third coil, respectively, wherein the first coil, the second coil, and the third coil are extended along a length of the coil between an inner longitudinal end portion and an outer longitudinal end portion of the coil, wherein an outer longitudinal end portion of the first coil is electrically connected with an inner longitudinal end portion of the second coil to form a common termination position, wherein any one of the first terminals is terminated on an inner longitudinal end portion of the first coil, and the other one of the first terminals is terminated on an outer longitudinal end portion of the second coil, wherein any one of the second terminals is terminated on the inner longitudinal end portion of the first coil, and the other one of the second terminals is terminated at the common termination position, and wherein the third terminals are terminated on an inner longitudinal end portion and an outer longitudinal end portion of the third coil.

### Advantageous Effects

In an embodiment of the disclosure, a plurality of coils may be implemented by using a coil manufacturing method of a sawing method, so that an effect of providing various functions may be provided.

In addition, a coil assembly may be manufactured by laminating a copper sheet, so that an effect of variously adjusting a gap between copper sheets, that is, a pattern gap, may be provided.

### BRIEF DESCRIPTION OF THE DRAWINGS

FIG. 1 is a view illustrating a coil assembly according to a first embodiment of the disclosure;

FIG. 2 is a longitudinal cross-sectional view of the coil assembly of FIG. 1;

FIG. 3 is a longitudinal cross-sectional view of a first film of FIG. 1;

FIG. 4 is a longitudinal cross-sectional view of a second film of FIG. 1;

FIG. 5 is a concept view illustrating the coil assembly of FIG. 1 as an electric circuit;

FIG. 6 is a view illustrating a coil assembly according to a second embodiment of the disclosure;

FIG. 7 is a longitudinal cross-sectional view of a first coil of FIG. 6;

FIG. 8 is a longitudinal cross-sectional view of a second coil of FIG. 6;

FIG. 9 is a view illustrating a coil assembly according to a third embodiment of the disclosure;

FIG. 10 is a longitudinal cross-sectional view of a third coil of FIG. 9; and

FIG. 11 is a concept view illustrating the coil assembly of FIG. 9 as an electric circuit.

### DETAILED DESCRIPTION

Hereinafter, specific embodiments for implementing the technical concept of the disclosure will be described in detail with reference to the accompanying drawings.

In the description of the disclosure, detailed explanations of related-art configurations or functions are omitted when it is deemed that they may unnecessarily obscure the essence of the disclosure.

In addition, it should be understood that, when a certain element is referred to as being ‘connected to’ another element, the certain element may be directly connected to another element, but there may be an intervening element therebetween.

The terms used in the detailed descriptions are used for the purpose of describing particular embodiments only and are not intended to limit the disclosure. The singular forms include the plural forms as well unless the context clearly indicates otherwise.

In addition, the terms including ordinal numbers such as ‘first’ and ‘second’ may be used to describe various elements, but these elements should not be limited by such terms. These terms are used for the purpose of distinguishing one element from another element only.

The term “includes” used in this specification specifies a specific feature, area, integer, step, operation, element, and/or component, and does not preclude the presence or addition of other specific features, areas, integers, steps, operations, elements, components, and/or groups.

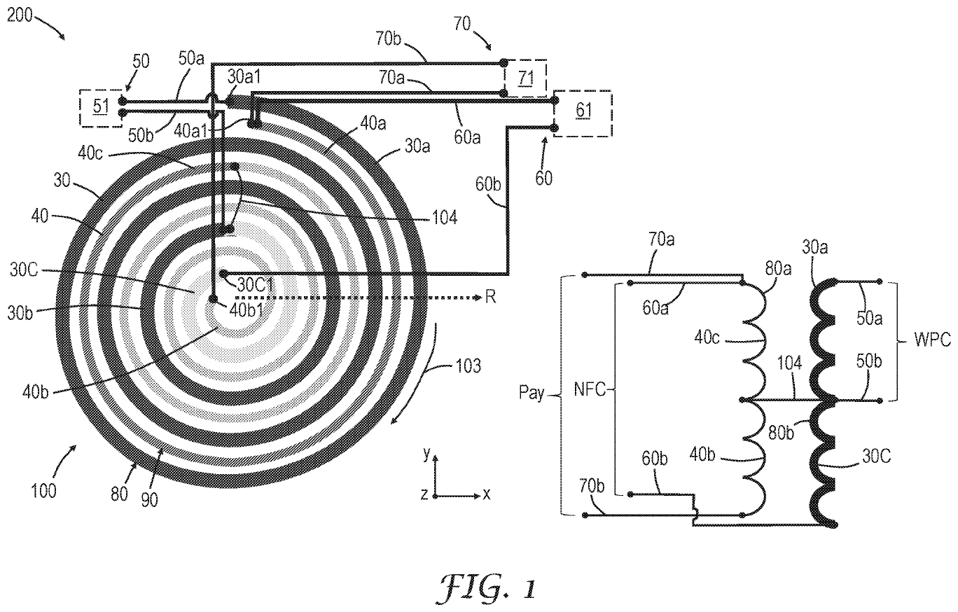

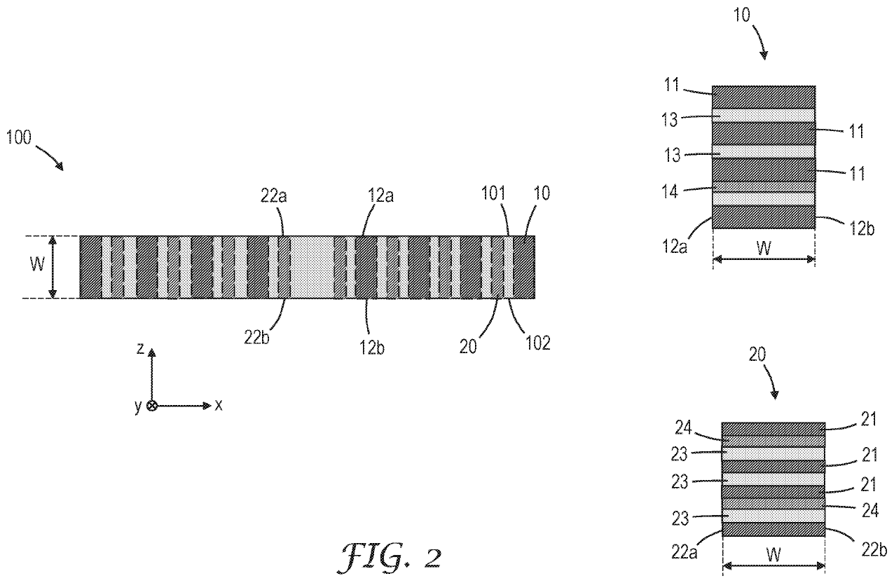

A radial direction used in this specification may be an R-axis direction of FIGS. 1, 6, and 9. In addition, a thickness direction may be a z-axis direction of FIGS. 2, 3, 4, 7, 8, and 10, and a width direction may be an x-axis direction of FIGS. 2, 3, 4, 7, 8, and 10.

Hereinafter, a detailed configuration of a coil assembly 1 according to a first embodiment of the disclosure will be described with reference to the drawings.

Referring to FIGS. 1 and 2 hereinafter, the coil assembly 1 according to the first embodiment of the disclosure may be installed in a portable electronic device such as a smartphone, a PDA, a tablet, or the like, and may provide various functions. For example, the coil assembly 1 may provide a wireless charging system (wireless power charging (WPC)) for wirelessly charging a battery, and may transmit and receive power through electromagnetic induction. In addition, the coil assembly 1 may provide one or more functions of a short-range wireless communication system (near field communication (NFC)) and a wireless electronic payment system (magnetic secure transmission (MST)). The coil assembly 1 may include a coil 100, terminals 200, and an electrically conductive wire 300.

The coil 100 may provide a portion through which a current flows. In addition, the coil 100 may be electrically connected with the terminals 200 and the electrically conductive wire 300. The coil 100 may include a first film 110, a second film 120, a first major coil surface 130, a second major coil surface 140, and a loop 150.

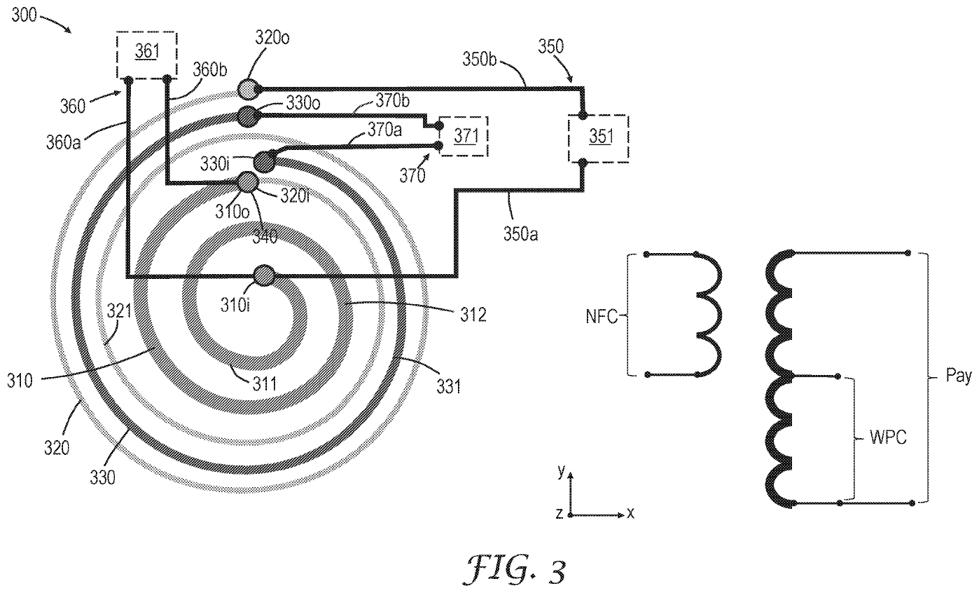

Referring to FIGS. 1 and 3, the first film 110 may be wound multiple times in order to form a plurality of loops 150. In addition, the first film 110 may be bonded to the second film 120 in the radial direction. The first film 110 may include a first electrically conductive layer 111, a first adhesive layer 112, and a first magneto-conductive layer 113.

The first electrically conductive layer 111 may include a metallic material enabling a current to flow therethrough. In addition, a plurality of first electrically conductive layers 111 may be provided. The plurality of first electrically conductive layers 111 may be disposed alternately with a plurality of first adhesive layers 112. For example, the first electrically conductive layer 111 may have a wider width than a second electrically conductive layer 121, which will be described below. This case has an effect that the first film 110 may have a relatively lower resistance than the second film 120. On the other hand, the first electrically conductive layer 111 may be electrically, physically connected with the terminals 200. For example, the first electrically conductive layer 111 may include copper.

The first adhesive layer 112 may include an adhesive material that is bonded to one layer adjacent to one side thereof, and to another layer adjacent to the other side thereof to bond between different layers. A plurality of first adhesive layers 112 may be provided. In addition, the first adhesive layer 112 may be disposed between two adjacent first electrically conductive layers 111 or between the first magneto-conductive layer 113 and the first electrically conductive layer 111. For example, the first adhesive layer 112 may connect the plurality of first electrically conductive layers 111 with each other, and may connect the first electrically conductive layer 111 and the first magneto-conductive layer 113. The first adhesive layer 112 may bond an inner side of the first film 110 and an outer side of the second film 120 in the radial direction, thereby connecting the first film 110 and the second film 120. Herein, the inner side of the radial direction may refer to a side of both sides of the first film 110 and the second film 120 that is adjacent to a center of the coil 100 in the radial direction, and the outer side of the radial direction may refer to a side that is far away from the center of the coil 100. For example, the first adhesive layer 112 may include epoxy.

The first magneto-conductive layer 113 may include a material having magnetism. The first magneto-conductive layer 113 may prevent the first film 110 and the second film 120 from interfering with each other when a current flows through the first film 110 and the second film 120. In addition, a plurality of first magneto-conductive layers 113 may be provided. The first magneto-conductive layer 113 may have substantially coextensive length and thickness with the first electrically conductive layer 111.

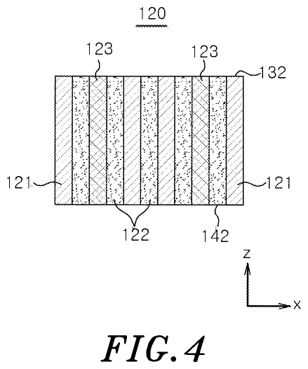

Referring to FIGS. 1 and 4, the second film 120 may be wound multiple times in order to form a plurality of loops 150. The second film 120 may include a second electrically conductive layer 121, a second adhesive layer 122, and a second magneto-conductive layer 123.

The second electrically conductive layer 121 may include a metallic material enabling a current to flow therethrough. In addition, a plurality of second electrically conductive layers 121 may be provided. The plurality of second electrically conductive layers 121 may be disposed alternately with a plurality of second adhesive layers 112. On the other hand, the second electrically conductive layer 121 may be electrically, physically connected with the terminals 200. For example, the second electrically conductive layer 121 may include copper.

The second adhesive layer 122 may include an adhesive material that is bonded to one layer adjacent to one side thereof, and to another layer adjacent to the other side thereof to bond between different layers. A plurality of second adhesive layers 122 may be provided. In addition, the second adhesive layer 122 may be disposed between two adjacent second electrically conductive layers 121 or between the second magneto-conductive layer 123 and the second electrically conductive layer 121. For example, the second adhesive layer 122 may connect the plurality of second electrically conductive layers 121 with each other, and may connect the second electrically conductive layer 121 and the second magneto-conductive layer 123. The second adhesive layer 122 may bond an outer side of the first film 110 and an inner side of the second film 120 in the radial direction, thereby connecting the first film 110 and the second film 120. For example, the second adhesive layer 122 may include epoxy.

The second magneto-conductive layer 123 may include a material having magnetism. The second magneto-conductive layer 123 may prevent the first film 110 and the second film 120 from interfering with each other when a current flows through the first film 110 and the second film 120. In addition, a plurality of second magneto-conductive layers 123 may be provided. The second magneto-conductive layer 123 may have substantially coextensive length and thickness with the second electrically conductive layer 121.

Referring back to FIG. 2, the major coil surfaces 130, 140 may face each other and may be substantially planar. In addition, the major coil surfaces 130, 140 may include a first major coil surface 130 which is one side surface of the coil 100 in the thickness direction, and a second major coil surface 140 which is the other side surface of the coil 100 in the thickness direction.

The first major coil surface 130 may include a first major coil surface 131 of the first film which is one side surface of the first film 110 in the thickness direction, and a first major coil surface 132 of the second film which is one side surface of the second film 120 in the thickness direction.

The second major coil surface 140 may include a second major coil surface 141 of the first film which is the other side surface of the first film 110 in the thickness direction, and a second major coil surface 142 of the second film which is the other side surface of the second film 120 in the thickness direction.

The first major coil surface 131 of the first film and the second major coil surface 141 of the first film may be extended between a first outer longitudinal end portion 151a and a first inner longitudinal end portion 153a, which will be described below.

In addition, the first major coil surface 132 of the second film and the second major coil surface 142 of the second film may be extended between a second outer longitudinal end portion 154a and a second inner longitudinal end portion 155a, which will be described below.

In the disclosure, the first major coil surface 131 of the first film, the first major coil surface 132 of the second film, the second major coil surface 141 of the first film, and the second major coil surface 142 of the second film may be referred to as corresponding end surfaces 131, 132, 141, 142. In addition, the major coil surfaces 130, 140 may include the corresponding end surfaces 131, 132, 141, 142.

In addition, the first film 110 and the second film 120 may have a substantially coextensive thickness T therebetween along the thickness direction, such that the first major coil surface 130 and the second major coil surface 140, which are substantially planar, include the corresponding end surfaces 131, 132, 141, 142, respectively. In addition, the first film 110 and the second film 120 may have a substantially coextensive length L along a winding direction of the coil 100, such that the first major coil surface 130 and the second major coil surface 140, which are substantially planar, include the corresponding end surfaces 131, 132, 141, 142, respectively. In other words, the first film 110 and the second film 120 may be extended to have the same thickness T and length L.

Referring back to FIG. 1, the coil 100 may be wound to form the plurality of loops 150 which are substantially concentric. In other words, the first film 110 and the second film 120 may be provided to form the plurality of loops 150 by winding a long film of a linear shape multiple times, respectively. In the disclosure, the loop 150 refers to a state in which the first film 110 and the second film 120 are wound multiple times to surround a predetermined center. In addition, the plurality of loops 150 do not mean loops having different centers, but mean the plurality of loops having the same center.

In addition, the plurality of loops may be connected with one another to indicate a concept including one loop. In other words, some of the plurality of loops 150 may be connected with one another, forming a loop around which the first film 110 is wound, and some other loops of the plurality of loops 150 may be connected with one another, forming another loop around which the second film 120 is wound. The loop 150 may include a first loop 151 of the first film, a second loop 152 of the first film, a third loop 153 of the first film, a first loop 154 of the second film, a second loop 155 of the second film, and a third loop 156 of the second film.

The first loop 151 of the first film may be a loop that is disposed on an outermost side of the first film 110, and may be referred to as a first outermost loop 151. The first loop 151 of the first film may include the first outer longitudinal end portion 151a which is a longitudinal outer end portion of the first film 110.

The second loop 152 of the first film may be disposed between the first loop 151 of the first film and the third loop 153 of the first film in the winding direction of the coil 100, thereby connecting the first loop 151 of the first film and the third loop 153 of the first film. In addition, the second loop 152 of the first film is a loop that is disposed relatively further inside than the first loop 151 of the first film.

The third loop 153 of the first film may be a loop that is disposed on an innermost side of the first film 110, and may be referred to as a first innermost loop 153. In addition, the third loop 153 of the first film is a loop that is disposed relatively further inside than the second loop 152 of the first film. The third loop 153 of the first film may include the first inner longitudinal end portion 153a which is a longitudinal inner end portion of the first film 110.

The first loop 154 of the second film may be a loop that is disposed on an outermost side of the second film 120, and may be referred to as a second outermost loop 154. The first loop 154 of the second film may include the second outer longitudinal end portion 154a which is a longitudinal outer end portion of the second film 120.

The second loop 155 of the second film may be a loop that is disposed on an innermost side of the second film 120, and may be referred to as a second innermost loop 155. In addition, the second loop 155 of the second film is a loop that is disposed relatively further inside than the first loop 154 of the second film. The second loop 155 of the second film may include the second inner longitudinal end portion 155a which is a longitudinal inner end portion of the second film 120.

The third loop 156 of the second film may be disposed between the first loop 154 of the second film and the second loop 155 of the second film in the winding direction of the coil 100, thereby connecting the first loop 154 of the second film and the second loop 155 of the second film. The third loop 156 of the second film is a loop that is disposed relatively further inside than the first loop 154 of the second film, and is disposed relatively further outside than the second loop 155 of the second film.

In addition, the third loop 156 of the second film may be disposed between the first loop 154 of the second film and the second loop 152 of the first film. For example, a distance from the center of the coil 100 to the third loop 156 of the second film is shorter than a distance from the center of the coil 100 to the first loop 154 of the second film, and is longer than a distance to the second loop 152 of the first film. In other words, an average radius of curvature of the third loop 156 of the second film is smaller than an average radius of curvature of the first loop 154 of the second film, and is larger than an average radius of curvature of the second loop 152 of the first film.

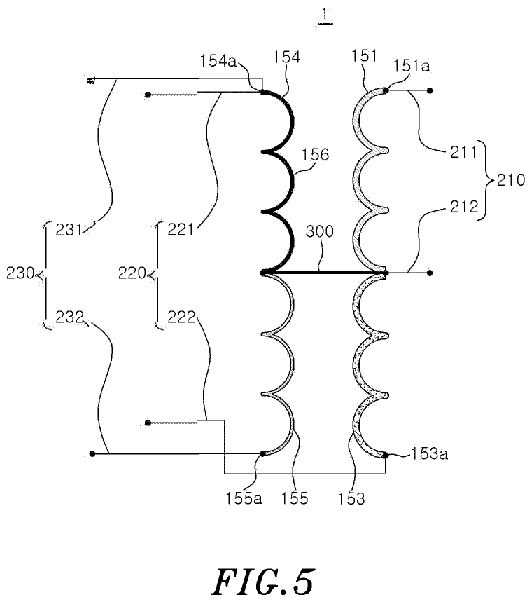

Referring to FIGS. 1 and 5, the terminals 200 may electrically connect different electronic devices 2, 3, 4. The terminals 200 may include first terminals 210, second terminals 220, and third terminals 230.

The first terminals 210 may be electrically connected with a first electronic device 2. The first terminals 210 may include two terminals 211, 212, and the two terminals 211, 212 may form one pair. In addition, any one 211 of the first terminals 210 is terminated on the first loop 151 of the first film, and the other one 212 of the first terminals 210 is terminated on the second loop 152 of the first film. The first terminals 210 may form a first electric circuit by electrically connecting the first electronic device 2, the first loop 151 of the first film, and the second loop 152 of the first film. For example, the first electric circuit may provide a function of a wireless charging system (WPC) The second terminals 220 may be electrically connected with a second electronic device 3.

The second terminals 220 may include two terminals 221, 222, and the two terminals 221, 222 may form one pair. In addition, any one 221 of the second terminals 220 is terminated on the first loop 154 of the second film, and the other one 222 of the second terminals 220 is terminated on the third loop 153 of the first film. The first terminals 210 may form a second electric circuit by electrically connecting the second electronic device 3, the first loop 154 of the second film, the electrically conductive wire 300, and the third loop 153 of the first film. For example, the second electric circuit may provide a function of a short-range wireless communication system (NFC).

The third terminals 230 may be electrically connected with a third electronic device 4. The third terminals 230 may include two terminals 231, 232, and the two terminals 231, 232 may form one pair. In addition, any one 231 of the third terminals 230 is terminated on the first loop 154 of the second film, and the other one 232 of the third terminals 230 is terminated on the second loop 155 of the second film. The second terminals 220 may form a third electric circuit by electrically connecting the third electronic device 4, the first loop 154 of the second film, and the second loop 155 of the second film. For example, the third electric circuit may provide a function of a wireless electronic payment system (MST).

The electrically conductive wire 300 may be disposed outside the coil 100, and may electrically connect different loops. In addition, the electrically conductive wire 300 may electrically connect the loops that have different distances from the center of the coil 100 in the radial direction. For example, the electrically conductive wire 300 may connect the third loop 153 of the first film to the third loop 156 of the second film. In addition, the first film 110 and the second film 120 which are different from each other may be electrically connected by the electrically conductive wire 300, and the second electric circuit may be formed.

In this case, the second electric circuit may wirelessly communicate with objects of different sizes within a short range through the electrically conductive wire 300. In a more specific example, when a current flows through the second electric circuit, the third loop 153 of the first film may wirelessly communicate with an object having a coil of a small size within a short range. In addition, the third loop 156 of the second film may wirelessly communicate with an object having a coil of a large size within a short range. The coil 100 may communicate with objects having coils of different sizes through the electrically conductive wire 300.

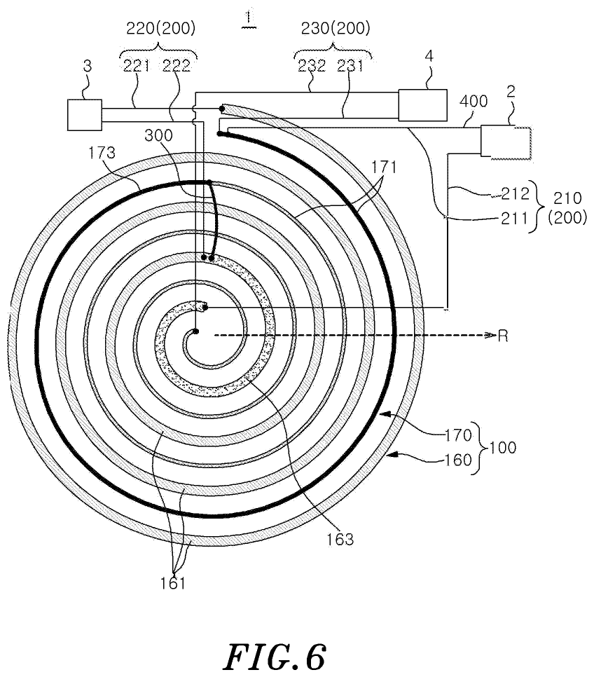

In addition to the above-described configuration, the coil 100 according to a second embodiment of the disclosure may include a first coil 160 and a second coil 170. Hereinafter, the second embodiment of the disclosure will be described by referring to FIGS. 6 to 8 more. In describing the second embodiment, differences from the above-described embodiment are mainly described, and the same description and reference numerals as in the above-described embodiment are referred to.

Referring to FIG. 6, the first coil 160 may be wound to form a plurality of first loops 161 which are substantially concentric. In addition, the second coil 170 may be wound to form a plurality of second loops 171 which are substantially concentric. The plurality of first loops 161 and the plurality of second loops 171 may be disposed alternately with each other in the radial direction.

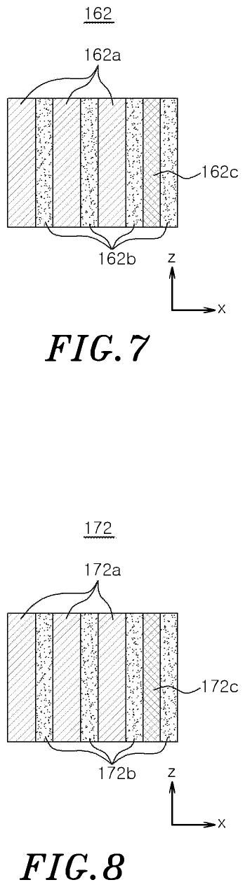

Referring to FIG. 7, the first coil 160 may include a first multilayer film 162. The first multilayer film 162 may include a first metal layer 162a, a first metal adhesive layer 162b, and a first coil magneto-conductive layer 162c.

A plurality of first metal layers 162a may be provided, and the plurality of first metal layers 162a may be laminated one on another. In addition, the plurality of first metal layers 162a may be spaced apart from one another along the radial direction of the coil 100. For example, the first metal layer 162a may include copper.

The first metal adhesive layer 162b may connect adjacent first metal layers 162a. A plurality of first metal adhesive layers 162b may be provided, and may be disposed alternately with the plurality of first metal layers 162a. For example, the first metal adhesive layer 162b may include epoxy.

The first coil magneto-conductive layer 162c may include a magnetic material, and may prevent interference between the first coil 160 and the second coil 170.

Referring to FIG. 8, the second coil 170 may include a second multilayer film 172. The second multilayer film 172 may include a second metal layer 172a, a second metal adhesive layer 172b, and a second coil magneto-conductive layer 172c.

A plurality of second metal layers 172a may be provided, and the plurality of second metal layers 172a may be laminated one on another. In addition, the plurality of second metal layers 172a may be spaced apart from one another along the radial direction of the coil 100. For example, the second metal layer 172a may include copper.

The second metal adhesive layer 172b may connect adjacent second metal layers 172a. A plurality of second metal adhesive layers 172b may be provided, and may be disposed alternately with the plurality of second metal layers 172a. For example, the second metal adhesive layer 172b may include epoxy.

The second coil magneto-conductive layer 172c may include a magnetic material, and may prevent interference between the first coil 160 and the second coil 170.

The first multilayer film 162 and the second multilayer film 172 described above may be referred to as multilayer films, and the first metal layer 162a and the second metal layer 172a may be referred to as metal layers or electrically conductive layers. In addition, the first metal adhesive layer 162b and the second metal adhesive layer 172b may be referred to as adhesive layers, and the first coil magneto-conductive layer 162c and the second coil magneto-conductive layer 172c may be referred to as magneto-conductive layers.

Referring back to FIG. 6, the coil 100 may include first terminals 210 and a first conductive circuit 400.

The first terminals 210 may be configured to be electrically connected to a first electronic device 2. The first terminals 210 may be terminated on the first coil 160 and the second coil 170 in order to form the first conductive circuit 400 between the first terminals 210. In other words, any one of the first terminals 210 may be terminated on the first coil 160, and the other one of the first terminals 210 may be terminated on the second coil 170.

The first coil 160 may include a first portion 163 connected with the second coil 170, and the second coil 170 may include a second portion 173 connected with the first coil 160. Herein, the first portion 163 may be a loop that is disposed inside among the plurality of first loops 161 of the first coil 160. For example, the first portion 163 may correspond to the third loop 153 of the first film of the first embodiment, and may be referred to as an inner loop of the first loop 161. In addition, the second portion 173 may be a loop that is disposed inside among the plurality of second loops 171 of the second coil 170. For example, the second portion 173 may correspond to the third loop 156 of the second film of the first embodiment, and may be referred to as an inner loop of the second loop 171.

The first portion 163 may form a first induction element 163, and the second portion 173 may form a second induction element 173. In addition, the first induction element 163 and the second induction element 173 may be connected with each other in series. For example, the first induction element 163 and the second induction element 173 may be electrically connected by the electrically conductive wire 300 on an outside of the coil 100. Herein, the electrically conductive wire 300 may electrically connect the inner loop of the first loop 161 with the inner loop of the second loop 171.

The first coil 160 and the second coil 170 may be disposed on the same plane.

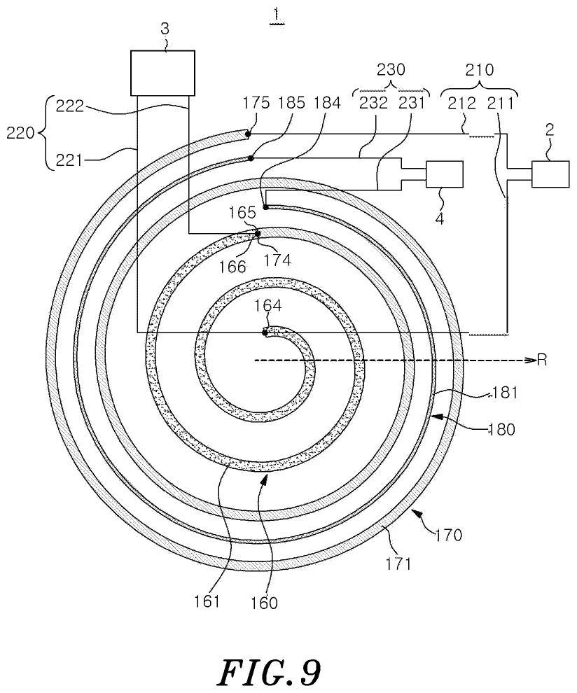

In addition to the above-described configurations, the coil 100 according to a third embodiment of the disclosure may include a first coil 160, a second coil 170, and a third coil 180. Hereinafter, the second embodiment of the disclosure will be described by referring to FIGS. 9 to 11 more. In describing the second embodiment, differences from the above-described embodiments are mainly described, and the same description and reference numerals as in the above-described embodiment are referred to.

Referring to FIG. 9, the first coil 160 may be wound to form a plurality of first loops 161 which are substantially concentric. The first coil 160 may include an inner longitudinal end portion 164 of the first coil and an outer longitudinal end portion 165 of the first coil, which are both side end portions in the longitudinal direction. In addition, the first coil 160 may include a first multilayer film 162.

The second coil 170 may be wound to form a plurality of second loops 171 which are substantially concentric. The second coil 170 may be provided to surround an outermost first loop 161 of the first coil 160 at least one time. In addition, the second coil 170 may be provided to surround an outermost third loop 181 of the third coil 180 at least one time. The second coil 170 may include an inner longitudinal end portion 174 of the second coil and an outer longitudinal end portion 175 of the second coil, which are both side end portions in the longitudinal direction.

In addition, the inner longitudinal end portion 174 of the second coil may be electrically connected with the outer longitudinal end portion 165 of the first coil. For example, the inner longitudinal end portion 174 of the second coil and the outer longitudinal end portion 165 of the first coil may be electrically connected at a common termination position 166. The second coil 170 may include a second multilayer film 172.

An outermost second loop 171 of the second coil 170 may include a second coil magneto-conductive layer 172c.

The third coil 180 may be wound to form a plurality of third loops 181 which are substantially concentric. The third coil 180 may be provided to surround the outermost first loop 161 of the first coil 160 at least one time. The third coil 180 may include an inner longitudinal end portion 184 of the third coil and an outer longitudinal end portion 185 of the third coil, which are both side end portions in the longitudinal direction. In addition, the third coil 180 may include a third multilayer film 182.

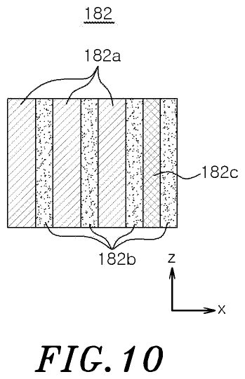

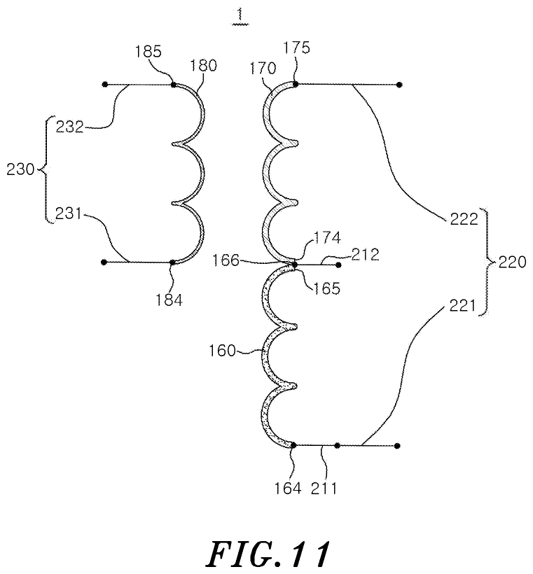

Referring to FIG. 10, the third multilayer film 182 may include a third metal layer 182a, a third metal adhesive layer 182b, and a third coil magneto-conductive layer 182c.

A plurality of third metal layers 182a may be provided, and the plurality of third metal layers 182a may be laminated one on another. In addition, the plurality of third metal layers 182a may be spaced apart from one another in the width direction of the third multilayer film 182 of the coil 100. For example, the third metal layer 182a may include copper. In addition, at least one of the plurality of third metal layers 182a may be disposed on the third coil magneto-conductive layer 182c.

The third metal adhesive layer 182b may be disposed between at least two adjacent third metal layers 182a to connect the two adjacent third metal layers 182a with each other. A plurality of third metal adhesive layers 182b may be provided, and may be disposed alternately with the plurality of third metal layers 182a. For example, the third metal adhesive layer 182b may include epoxy.

The third coil magneto-conductive layer 182c may include a magnetic material, and may prevent interference between the first coil 160 and the third coil 170.

The third multilayer film 182 described above may be referred to as a multilayer film, and the third metal layer 182a may be referred to as a metal layer or an electrically conductive layer. In addition, the third metal adhesive layer 182b may be referred to as an adhesive layer, and the third coil magneto-conductive layer 182c may be referred to as a magneto-conductive layer.

Referring to FIGS. 9 and 11, the first coil 160, the second coil 170, and the third coil 180 may be extended along the length of the coil 100 between the inner longitudinal end portions 164, 174, 184 and the outer longitudinal end portions 165, 175, 185 of the coil 100. Herein, the inner longitudinal end portions 164, 174, 184 and the outer longitudinal end portions 165, 175, 185 of the coil 100 refer to both side end portions of the coil 100 in the longitudinal direction.

In addition, any one 211 of the first terminals 210 is terminated on the inner longitudinal end portion 164 of the first coil, and the other one 212 of the first terminals 210 is terminated on the outer longitudinal end portion 175 of the second coil.

Any one 221 of the second terminals 220 is terminated on the inner longitudinal end portion 164 of the first coil, and the other one 222 of the second terminals 220 is terminated at the common termination position 166.

Any one 231 of the third terminals 230 is terminated on the inner longitudinal end portion 184 of the third coil, and the other one 232 of the third terminals 230 is terminated on the outer longitudinal end portion 185 of the third coil.

The following is a list of embodiments of present disclosure.

Item 1 relates to a coil assembly including: a coil; and at least one pair of terminals among first terminals, second terminals, and third terminals for electrically connecting different electronic devices, wherein the coil includes: major coil surfaces which face each other and are substantially planar; and at least a first film and a second film which are laminated and are wound to form a plurality of loops which are substantially concentric, wherein the first film and the second film include at least one electrically conductive layer, respectively, wherein the first film and the second film have a substantially coextensive thickness therebetween along a thickness direction of the coil, and have a substantially coextensive length therebetween in a winding direction of the coil, such that the substantially planar major coil surfaces include corresponding end surfaces of the first film and the second film, respectively, wherein any one of the first terminals is terminated on a first loop of the first film, and the other one of the first terminals is terminated on a second loop of the first film, wherein the second loop of the first film is relatively further inside than the first loop of the first film, wherein any one of the second terminals is terminated on a first loop of the second film, and the other one of the second terminals is terminated on a third loop of the first film, wherein the third loop of the first film is relatively further inside than the second loop of the first film, wherein any one of the third terminals is terminated on the first loop of the second film, and the other one of the third terminals is terminated on a second loop of the second film, wherein the second loop of the second film is relatively further inside than the third loop of the first film, wherein an electrically conductive wire on an outside of the coil connects the third loop of the first film with a third loop of the second film, and wherein the third loop of the second film is disposed between the first loop of the second film and the second loop of the first film.

Item 2 relates to the coil assembly, wherein the plurality of substantially concentric loops of at least the first film and the second film include a first innermost loop and a second innermost loop, respectively, wherein the first innermost loop and the second innermost loop include a first inner longitudinal end portion and a second inner longitudinal end portion of the first film and the second film, respectively, wherein the plurality of substantially concentric loops of at least the first film and the second film include a first outermost loop and a second outermost loop, respectively, wherein the first outermost loop and the second outermost loop include a first outer longitudinal end portion and a second outer longitudinal end portion of the first film and the second film, respectively, wherein the third loop of the first film is the first innermost loop of the first film, wherein the second loop of the second film is the second innermost loop of the second film, wherein the first loop of the first film is the first outermost loop of the first film, and wherein the first loop of the second film is the second outermost loop of the second film.

Item 3 relates to the coil assembly, wherein the first film and the second film include a plurality of adhesive layers and a plurality of electrically conductive layers which alternate with the plurality of adhesive layer, respectively.

Item 4 relates to the coil assembly, wherein at least one of the first film and the second film includes one or more magneto-conductive layers which have substantially coextensive length and thickness with the at least one electrically conductive layer in at least one of the first film and the second film.

Item 5 relates to a coil assembly including: a first coil and a second coil which are on a same plane; and first terminals configured to be electrically connected to a first electronic device, wherein the first coil and the second coil include a plurality of first loops of the first coil and a plurality of second loops of the second coil which alternate with each other, wherein at least one of the first coil and the second coil includes a multilayer film including at least two metal layers which are laminated and are spaced apart from each other along a radial direction of the coil, wherein the first terminals are terminated on the first coil and the second coil to form a first conductive circuit between the first terminals, wherein the first conductive circuit includes a first portion of the first coil forming a first induction element, and a second portion of the second coil forming a second induction element, and wherein the first induction element and the second induction element are connected with each other in series.

Item 6 relates to the coil assembly, wherein the first induction element and the second induction element are electrically connected by an electrically conductive wire on an outside of the coil, the electrically conductive wire being configured to connect an inner loop of the first loop and an inner loop of the second loop.

Item 7 relates to a coil assembly including: a coil including a first coil, a second coil, and a third coil which are on a same plane; and at least one pair of terminals among first terminals, second terminals, and third terminals for electrically connecting different electronic devices, wherein the first coil includes a plurality of first loops, wherein the second coil and the third coil surround an outermost first loop of the first coil at least one time so as to form at least one second loop of the second coil and at least one third loop of the third coil, respectively, wherein the first coil, the second coil, and the third coil are extended along a length of the coil between an inner longitudinal end portion and an outer longitudinal end portion of the coil, wherein an outer longitudinal end portion of the first coil is electrically connected with an inner longitudinal end portion of the second coil to form a common termination position, wherein any one of the first terminals is terminated on an inner longitudinal end portion of the first coil, and the other one of the first terminals is terminated on an outer longitudinal end portion of the second coil, wherein any one of the second terminals is terminated on the inner longitudinal end portion of the first coil, and the other one of the second terminals is terminated at the common termination position, and wherein the third terminals are terminated on an inner longitudinal end portion and an outer longitudinal end portion of the third coil.

Item 8 relates to the coil assembly, wherein the third coil includes a multilayer film, wherein the multilayer film includes a plurality of electrically conductive layers which are spaced apart from each other along a width direction of the multilayer film, an adhesive layer, and a magneto-conductive layer, wherein the adhesive layer is disposed between at least two adjacent electrically conductive layers, and wherein at least one of the plurality of electrically conductive layers is disposed on the magneto-conductive layer.

Item 9 relates to the coil assembly, wherein an outermost second loop of the second coil includes a magneto-conductive layer.

Although embodiments of the disclosure have been described in the form of specific embodiments, these are merely examples and the disclosure is not limited thereto, and should be interpreted as having the widest scope of the technical concept disclosed in the specification. An ordinary skilled person in the related art may embody a pattern of a shape that is not set forth herein by combining/substituting the disclosed embodiments, without departing from the scope of the disclosure. In addition, an ordinary skilled person in the related art may easily change or modify the disclosed embodiments based on the detailed descriptions, and it is obvious that the changes or modifications belong to the right scope of the disclosure.

Description of Reference Numerals

| | |
|---|---|
| 1: coil | 2: first electronic device |
| 3: second electronic device | 4: third electronic device |
| 100: coil | 110: first film |
| 111: first electrically conductive layer | 112: first adhesive layer |
| 113: first electrically conductive layer | 120: second film |
| 121: second electrically conductive layer | 122: second adhesive layer |
| 123: second electrically conductive layer | 130: first major coil surface |
| 140: second major coil surface | 150: loop |
| 151: outermost loop | 151a: first outer longitudinal end portion |
| 153: innermost loop | 153a: first inner longitudinal end portion |
| 154: second outermost loop | 154a: second outer longitudinal end portion |
| 155: second innermost loop | 155a: second inner longitudinal end portion |
| 160: first coil | 161: first loop |
| 162: first multilayer film | 162a first metal layer |
| 162b: first metal adhesive layer | 162c: first coil magneto-conductive layer |
| 163: first portion | 164: first inner longitudinal end portion |
| 165: first outer longitudinal end portion | 166: common termination position |
| 170: second coil | 171: second loop |
| 172: second multilayer film | 172a second metal layer |
| 172b: second metal adhesive layer | 172c: second coil magneto-conductive layer |
| 173: second portion | 174: second inner longitudinal end portion |
| 175: second outer longitudinal end portion | 180: third coil |
| 181: third loop | 182: third multilayer film |
| 182a: third metal layer | 182b: third metal adhesive layer |
| 182c: third coil magneto-conductive layer | 184: third inner longitudinal end portion |
| 185: third outer longitudinal end portion | 200: terminals |
| 210: first terminals | 220: second terminals |
| 230: third terminals | 300: electrically conductive wire |
| 400: first conductive circuit | |

What is claimed is:

1. A coil assembly comprising:
a coil; and
at least one pair of terminals among first terminals, second terminals, and third terminals for electrically connecting different electronic devices,
wherein the coil comprises:
major coil surfaces which face each other and are substantially planar; and
at least a first film and a second film which are laminated and are wound to form a plurality of loops which are substantially concentric,
wherein the first film and the second film comprise at least one electrically conductive layer, respectively,
wherein the first film and the second film
have a substantially coextensive thickness therebetween along a thickness direction of the coil, and have a substantially coextensive length therebetween in a winding direction of the coil, such that the substantially planar major coil surfaces comprise corresponding end surfaces of the first film and the second film, respectively,
wherein any one of the first terminals is terminated on a first loop of the first film, and the other one of the first terminals is terminated on a second loop of the first film,
wherein the second loop of the first film is relatively further inside than the first loop of the first film,
wherein any one of the second terminals is terminated on a first loop of the second film, and the other one of the second terminals is terminated on a third loop of the first film,
wherein the third loop of the first film is relatively further inside than the second loop of the first film,
wherein any one of the third terminals is terminated on the first loop of the second film, and the other one of the third terminals is terminated on a second loop of the second film,
wherein the second loop of the second film is relatively further inside than the third loop of the first film,
wherein an electrically conductive wire on an outside of the coil connects the third loop of the first film with a third loop of the second film, and
wherein the third loop of the second film is disposed between the first loop of the second film and the second loop of the first film.

2. The coil assembly of claim 1,
wherein the plurality of substantially concentric loops of at least the first film and the second film comprise a first innermost loop and a second innermost loop, respectively,
wherein the first innermost loop and the second innermost loop comprise a first inner longitudinal end portion and a second inner longitudinal end portion of the first film and the second film, respectively,
wherein the plurality of substantially concentric loops of at least the first film and the second film comprise a first outermost loop and a second outermost loop, respectively,
wherein the first outermost loop and the second outermost loop comprise a first outer longitudinal end portion and a second outer longitudinal end portion of the first film and the second film, respectively,
wherein the third loop of the first film is the first innermost loop of the first film,
wherein the second loop of the second film is the second innermost loop of the second film,
wherein the first loop of the first film is the first outermost loop of the first film, and
wherein the first loop of the second film is the second outermost loop of the second film.

3. The coil assembly of claim 1,
wherein the first film and the second film comprise a plurality of adhesive layers and a plurality of electrically conductive layers which alternate with the plurality of adhesive layer, respectively.

4. The coil assembly of claim 1,
wherein at least one of the first film and the second film comprises one or more magneto-conductive layers which have substantially coextensive length and thickness with the at least one electrically conductive layer in at least one of the first film and the second film.

5. A coil assembly comprising:
a first coil and a second coil which are on a same plane; and
first terminals configured to be electrically connected to a first electronic device,
wherein the first coil and the second coil comprise
a plurality of first loops of the first coil and a plurality of second loops of the second coil which alternate with each other,
wherein at least one of the first coil and the second coil comprises a multilayer film comprising at least two metal layers which are laminated and are spaced apart from each other along a radial direction of the coil,
wherein the first terminals are terminated on the first coil and the second coil to form a first conductive circuit between the first terminals,
wherein the first conductive circuit comprises a first portion of the first coil forming a first induction element, and a second portion of the second coil forming a second induction element, and
wherein the first induction element and the second induction element are connected with each other in series.

6. The coil assembly of claim 5,
wherein the first induction element and the second induction element are electrically connected by an electrically conductive wire on an outside of the coil, the electrically conductive wire being configured to connect an inner loop of the first loop and an inner loop of the second loop.

7. A coil assembly comprising:
a coil comprising a first coil, a second coil, and a third coil which are on a same plane; and
at least one pair of terminals among first terminals, second terminals, and third terminals for electrically connecting different electronic devices,
wherein the first coil comprises a plurality of first loops,
wherein the second coil and the third coil
surround an outermost first loop of the first coil at least one time so as to form at least one second loop of the second coil and at least one third loop of the third coil, respectively,
wherein the first coil, the second coil, and the third coil are extended along a length of the coil between an inner longitudinal end portion and an outer longitudinal end portion of the coil,
wherein an outer longitudinal end portion of the first coil is electrically connected with an inner longitudinal end portion of the second coil to form a common termination position,
wherein any one of the first terminals is terminated on an inner longitudinal end portion of the first coil, and the other one of the first terminals is terminated on an outer longitudinal end portion of the second coil,
wherein any one of the second terminals is terminated on the inner longitudinal end portion of the first coil, and the other one of the second terminals is terminated at the common termination position, and
wherein the third terminals are terminated on an inner longitudinal end portion and an outer longitudinal end portion of the third coil.

8. The coil assembly of claim 7,
wherein the third coil comprises a multilayer film,
wherein the multilayer film comprises a plurality of electrically conductive layers which are spaced apart from each other along a width direction of the multilayer film, an adhesive layer, and a magneto-conductive layer,
wherein the adhesive layer is disposed between at least two adjacent electrically conductive layers, and
wherein at least one of the plurality of electrically conductive layers is disposed on the magneto-conductive layer.

9. The coil assembly of claim 7,
wherein an outermost second loop of the second coil comprises a magneto-conductive layer.
